(19) United States
(12) Patent Application Publication
(10) Pub. No.: US 2026/0352966 A1
(43) Pub. Date: Nov. 5, 2026

(54) CORRECTION DEVICE, CORRECTION METHOD, AND ELECTRONIC APPARATUS

(71) Applicant: SONY SEMICONDUCTOR SOLUTIONS CORPORATION, KANAGAWA (JP)

(72) Inventors: NOBUYUKI NAGAI, KANAGAWA (JP); AKIHIRO MORIMOTO, KANAGAWA (JP); MASASHI TSUCHIYAMA, KUMAMOTO (JP); RYOUJI TANIGUCHI, KANAGAWA (JP)

(21) Appl. No.: 19/473,203

(22) PCT Filed: Apr. 12, 2024
(86) PCT No.: PCT/JP2024/014883

§ 371 Date: Oct. 7, 2025

(30) Foreign Application Priority Data
Apr. 21, 2023 (JP) 2023-070364

(51) Int. Cl. H04N 23/955; H04N 23/55; H04N 23/56; H04N 23/80; H04N 25/79

(52) U.S. Cl. CPC H04N 23/955; H04N 23/55; H04N 23/56; H04N 23/80; H04N 25/79

(57) ABSTRACT

To improve the accuracy of information for restoring an image. The correction device corrects restoration information in an imaging device. The imaging device includes a mask that modulates an incident light ray from a subject, an imaging element that images the incident light ray modulated by the mask and generates an observation image, and a processing unit that, based on the restoration information for each of a plurality of specific distances, performs a process of restoring an image of the subject, from the observation image, for each of the plurality of specific distances, the plurality of specific distances each being a distance to the subject that is a target of restoration of the image of the subject from the observation image. The correction device includes a correction control unit that performs control such that a plurality of correction light source images are generated, the plurality of correction light source images each being an image based on an incident light ray from a correction light source disposed for a corresponding one of the specific distances, and a calculation unit that generates correction information for correcting the restoration information for each of the specific distances, based on the plurality of correction light source images.

### TECHNICAL FIELDS

The present disclosure relates to a correction device, a correction method, and an electronic apparatus.

### BACKGROUND ART

In contrast to a camera including an imaging element and a photographic lens that forms an image of a subject on the imaging element, a lensless camera without a photographic lens is proposed (see PTL 1, for example). The lensless camera includes, instead of a photographic lens, a mask having a pattern formed of a light transmissive region and a light non-transmissive region, and the lensless camera generates an observation image, which is an image obtained by imaging incident light rays modulated using the mask. Next, the lensless camera performs signal processing on the observation image to restore the image of the subject. The lensless camera has information on how radiated light rays from the subject are modulated by the mask and projected on the imaging element, and performs the signal processing on the observation image with use of the information.

The information changes depending on variations in attachment positions of the mask and the imaging element. Therefore, in the above-described known technique, calibration of the information (an imaging matrix or the like) is performed for each lensless camera.

### CITATION LIST

### Patent Literature

[PTL 1] WO 2019/176349

### SUMMARY

### Technical Problem

However, in the above-described known technique, there is room for improvement in terms of accurately acquiring restoration information generated to be used in image restoration.

Here, the present disclosure proposes a correction device, a correction method, and an electronic apparatus that Correct information for restoring an image for each distance to a subject.

### Solution to Problem

A correction device according to the present disclosure is a correction device that corrects restoration information in an imaging device including a mask that modulates an incident light ray from a subject, an imaging element that images the incident light ray modulated by the mask and generates an observation image, and a processing unit that, based on the restoration information for each of a plurality of specific distances, performs a process of restoring an image of the subject, from the observation image, for each of the plurality of specific distances, the plurality of specific distances each being a distance to the subject that is a target of restoration of the image of the subject from the observation image. The correction device includes a correction control unit configured to perform control such that a plurality of correction light source images are generated, the plurality of correction light source images each being an image based on an incident light ray from a correction light source disposed for a corresponding one of the specific distances, and a calculation unit configured to generate Correction information for correcting the restoration information for each of the specific distances, based on the plurality of correction light source images.

### BRIEF DESCRIPTION OF DRAWINGS

FIG. 1 is an explanatory diagram for explaining the principle of a lensless camera.

FIG. 2 is an explanatory diagram for explaining the principle of the lensless camera.

FIG. 3 is a diagram illustrating a configuration example of an electronic apparatus according to a first embodiment of the present disclosure.

FIG. 4A is a diagram illustrating a configuration example of a correction light source according to the first embodiment of the present disclosure.

FIG. 4B is a diagram illustrating an example of generation of a correction light source image according to the first embodiment of the present disclosure.

FIG. 5 is a chart showing an example of a processing procedure of correction information generation processing according to the first embodiment of the present disclosure.

FIG. 6 is a diagram illustrating an example of generation of a correction light source image according to a second embodiment of the present disclosure.

FIG. 7 is a diagram illustrating a configuration example of a correction light source according to a second embodiment of the present disclosure.

FIG. 8 is a diagram illustrating an example of arrangement of correction light sources according to the second embodiment of the present disclosure.

FIG. 9 is a diagram illustrating a configuration example of a correction device according to a second embodiment of the present disclosure.

FIG. 10 is a diagram illustrating another configuration example of the correction device according to the second embodiment of the present disclosure.

FIG. 11A is a diagram illustrating a configuration example of an electronic apparatus according to a third embodiment of the present disclosure.

FIG. 11B is a diagram illustrating a configuration example of the electronic apparatus according to the third embodiment of the present disclosure,

FIG. 12 is a diagram illustrating another configuration example of the electronic apparatus according to the third embodiment of the present disclosure.

FIG. 13 is a diagram illustrating another configuration example of the electronic apparatus according to the third embodiment of the present disclosure.

### DESCRIPTION OF EMBODIMENTS

Hereinafter, embodiments of the present disclosure will be described in detail with reference to the drawings. The description will be made in the following order. In the following embodiments, the same components are denoted by the same reference numerals, and redundant description thereof will be omitted.
1. Principle of Lensless Camera
2. First Embodiment
3. Second Embodiment
4. Third Embodiment

### 1. Principle of Lensless Camera

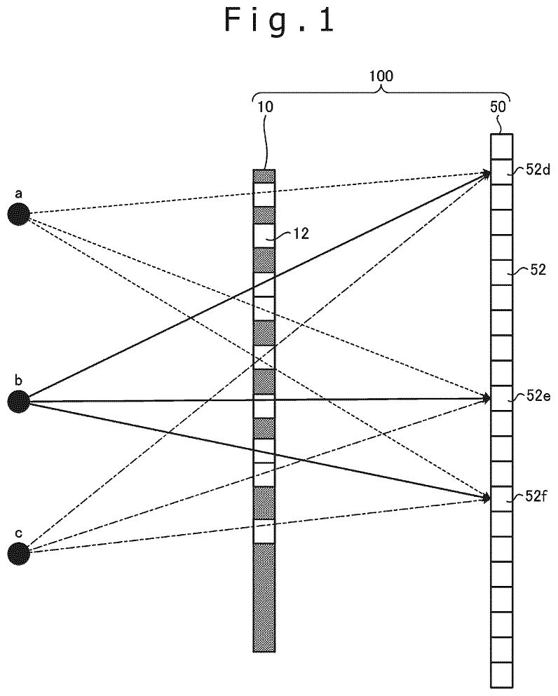

First, before describing the embodiments of the present disclosure in detail, an overview and a principle of a lensless camera (imaging device) will be described with reference to FIG. 1.

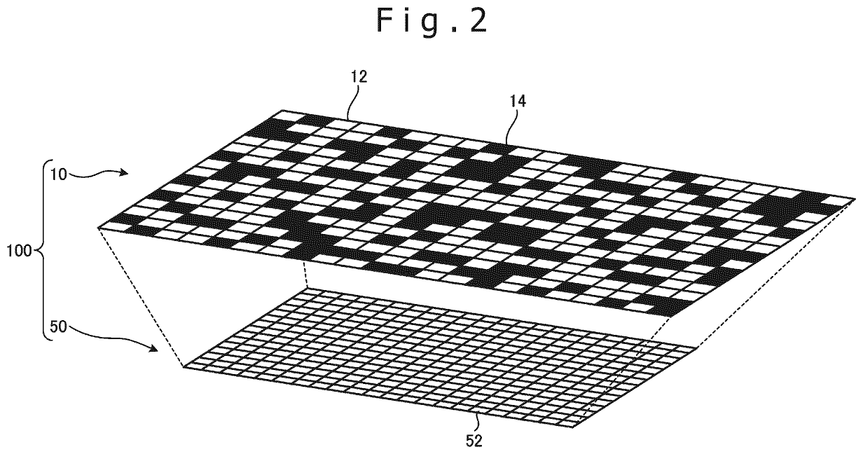

FIGS. 1 and 2 are explanatory diagrams for explaining the principle of the lensless camera. As illustrated in FIG. 1, an imaging device (lensless camera) 100 includes a binary mask (optical element) 10 and an image sensor 50. The binary mask 10 is a mask having a predetermined pattern including a plurality of light transmitting filters 12 and a plurality of light non-transmitting filters (not illustrated) arrayed in a two-dimensional lattice pattern, for example. The image sensor 50 includes a plurality of pixels 52 arrayed in a two-dimensional lattice pattern or in one column (or one row) on a light receiving surface. Each of the pixels 52 generates an electronic signal (observation data) by receiving light rays from points of a scene to be imaged. Further, in the lensless camera, by projecting the electronic signal at a position on a plane corresponding to a position of the corresponding pixel 52, an imaged image of an actual scene can be obtained. At this time, the light rays from the points of the scene pass through the light transmitting filters 12 of the binary mask 10 and are received by the pixels 52 of the image sensor 50.

Further, the imaging principle of the imaging device 100 will be described in detail. In the following description, it is assumed that the light rays from the points of the scene to be imaged are light rays from light sources a, b, and c illustrated in FIG. 1. For example, in the example illustrated in FIG. 1, the light rays from the light source a pass through the light transmitting filters 12 of the binary mask 10 and are received by pixels 52d, 52e, and 52f. The light rays from the light source b pass through the light transmitting filters 12 of the binary mask 10 and are received by the pixels 52d, 52e, and 52f. Further, the light rays from the light source c pass through the light transmitting filters 12 of the binary mask 10 and are received by the pixels 52d, 52e, and 52f. Here, when intensities of the light rays of the light sources a, b, and c are denoted by a, b, and c, respectively, light intensities I_{d}, Iₛ, and I_{f} received respectively by the pixels 52d, 52e, and 52f are expressed by the following Equation (1). In Equation (1), α₁ to α₃, β₁ to β₃, and γ₁ to γ₃ are transmission coefficients of the light transmitting filters 12 of the binary mask 10.

$$\begin{matrix}Equation 1 & \\ {I}_{d} = {α}_{1} \times a + {β}_{1} \times b + {γ}_{1} \times c & ( 1 )\end{matrix}$$

$${I}_{e} = {α}_{2} \times a + {β}_{2} \times b + {γ}_{2} \times c$$

$${I}_{f} = {α}_{3} \times a + {β}_{3} \times b + {γ}_{3} \times c$$

As understood from the above Equation (1), the light rays received by the pixels 52d, 52e, and 52f are each a mixture of the light rays emitted from the light sources a, b, and c, and not composed of only the light rays from a subject included in the actual scene (for example, the light rays from one of the light sources in FIG. 1). Therefore, the imaged image of the actual scene that can be initially acquired by the imaging device 100 is not an image in which the image of the subject included in the scene is formed, but is blurred due to the superimposition of images. Thus, in performing imaging using the imaging device 100, in order to obtain an imaged image of an actual scene such as a subject the image of which has been formed, an imaged image of the actual scene, such as a desired subject, is reconstructed from the superimposed images.

Here, when the light rays emitted from the plurality of points in the scene are expressed as a light vector X, and observation data of the plurality of pixels 52 that receive the light rays is expressed as an observation value vector Y, a relationship between the light vector X and the observation value vector Y can be expressed by the following Equation (2).

Equation 2

\vec{Y}=F\vec{X}, (2)

In the above Equation (2), F is a matrix representing the transmission coefficients of the light transmitting filters 12 of the binary mask 10 having the two-dimensional pattern.

Therefore, in the imaging using the imaging device 100, in order to reconstruct the imaged image of the actual scene such as the subject the image of which has been formed, the light vector X satisfying the above Equation (2) for the light rays from the subject or the like included in the scene is calculated from the observation value vector Y. Specifically, since the observation value vector Y is made clear by the image sensor 50, the light vector X can be calculated by solving the matrix F for X. For this purpose, the pattern of the binary mask 10 is required to satisfy a condition for obtaining the solution.

As illustrated in FIG. 2, the binary mask (optical element) 10 is used by overlapping the image sensor (line sensor or area sensor) 50. In other words, as illustrated in FIG. 2, the imaging device 100 includes the image sensor 50 including one or more scanning lines (rows) (specifically, one scanning line includes a plurality of pixels arranged along a row direction), and the binary mask 10 overlapping the image sensor 50. As illustrated in FIG. 2, the binary mask 10 includes a plurality of unit elements each having a size substantially equal to that of the pixel 52 of the image sensor 50, and each of the unit elements includes the light transmitting filter 12 and a light non-transmitting filter 14, More specifically, the binary mask 10 has the predetermined pattern including the plurality of light transmitting filters 12 and the plurality of light non-transmitting filters arranged in the two-dimensional lattice pattern. In other words, the binary mask 10 can be said to be a type of optical element.

The autocorrelation function of the predetermined pattern repeated on the binary mask 10 has a sharp peak and very small side lobes with respect to the peak. By using such a binary mask 10, the above Equation (2) can be solved, and thus the imaged image of the actual scene can be reconstructed from the observation data (signals) acquired by the image sensor 50.

### 2. First Embodiment

### Configuration of Electronic Apparatus

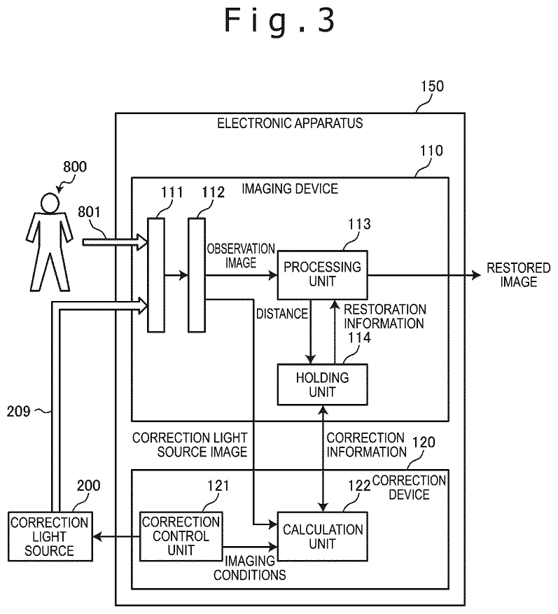

FIG. 3 is a diagram illustrating a configuration example of an electronic apparatus according to the first embodiment of the present disclosure. FIG. 3 is a block diagram illustrating a configuration example of an electronic apparatus 150. The electronic apparatus 150 is an apparatus that generates an image of a subject. FIG. 3 illustrates an example in which imaging is performed based on incident light rays 801 from a subject 800, to generate an image. The electronic apparatus 150 includes an imaging device 110 and a correction device 120.

The imaging device 110 is the device corresponding to the lensless camera described above. The imaging device 110 includes a mask 111, an imaging element 112, a processing unit 113, and a holding unit 114.

The mask 111 corresponds to the binary mask described above, and modulates the incident light rays 801 from the subject 800.

The imaging element 112 generates an image based on the incident light rays 801. The imaging element 112 includes a pixel array unit in which a plurality of pixels that perform photoelectric conversion of the incident light rays to generate signals (pixel signals) are arranged in a two-dimensional matrix, and a processing unit that generates image data, based on the pixel signals. The imaging element 112 in FIG. 3 images the incident light rays modulated by the mask 111, and generates an observation image that is the image based on the incident light rays.

The imaging element 112 in FIG. 3 generates a correction light source image, and outputs the correction light source image to the correction device 120. The correction light Source image is an image based on incident light rays from a correction light source. In FIG. 3, a correction light source 200 is illustrated. The imaging element 112 in FIG. 3 generates the correction light source image based on incident light rays 209 from the correction light source 200.

The processing unit 113 restores an image of the subject 800 from the observation image generated by the imaging element 112, and outputs a restored image. The restored image of the subject 800 is referred to as the restored image. The restoration can be performed based on restoration information. As described above, a predetermined relationship is established between the observation image and the restored image. For example, the following relational expression is established between the observation image and the restored image.

g(x,y)=PSF(x,y)×f(x,y)+n (3)

Here, g(x, y) represents the observation image. Further, f(x, y) represents the restored image. Further, PSF (x, y) represents a point spread function. Further, n represents noise. The restoration of the image of the subject 800 can be generated by calculating backward from the observation image and PSF (x, y). PSF (x, y) in Equation (3) corresponds to the restoration information.

The generation of the restored image is performed for a specific distance which is a distance set in advance among distances to the subject. That is, the imaging device 110 generates the image of the subject at the specific distance. The specific distance is thus a distance to the subject for which the image of the subject is to be restored. A plurality of distances can be set as specific distances. In this case, the restoration information is arranged for each of the plurality of specific distances. The restoration information is held in the holding unit 114 to be described later. The processing unit 113 reads out the restoration information for the specific distance from the holding unit 114 when restoring the image. Next, the processing unit 113 generates the restored image using the read restoration information.

The processing unit 113 further corrects the restoration information. The correction of the restoration information can be performed by adjusting the restoration information on the basis of correction information to be described later. In reading the restoration information from the holding unit 114, in a case in which the correction information corresponding to the restoration information is held, the processing unit 113 further reads the correction information. Next, the processing unit 113 corrects the restoration information on the basis of the correction information, and performs the restoration using the corrected restoration information.

The holding unit 114 holds a plurality of pieces of restoration information for the respective specific distances, The holding unit 114 outputs, to the processing unit 113, the restoration information for the distance output from the processing unit 113. The holding unit 114 further holds the correction information.

The above-described restoration information is generated in advance, based on the shape of the mask 111, on a distance between the mask 111 and the imaging element 112, and on the specific distance. The restoration information needs to be corrected for each of the imaging devices 110. This is because the shape of the mask 111, the distance to the imaging element 112, and the like vary.

The correction device 120 generates the correction information for correcting the restoration information. The correction device 120 generates the correction information corresponding to each piece of restoration information for a corresponding one of the specific distances that is held in the holding unit 114 of the imaging device 110. The correction device 120 in FIG. 3 includes a correction control unit 121 and a calculation unit 122.

The correction control unit 121 generates the correction light source image used for the correction of the restoration information. Here, the correction light source image is an image based on incident light rays from the correction light source. The correction control unit 121 performs control to generate the correction light source image for each of the specific distances. The correction control unit 121 further controls the correction light source 200.

The calculation unit 122 generates the correction information, based on the correction light source image. The calculation unit 122 generates the correction information of the restoration information for each of the specific distances read from the holding unit 114, and causes the holding unit 114 to hold the correction information. The correction of the restoration information will be described below.

### Generation of Correction Light Source Image

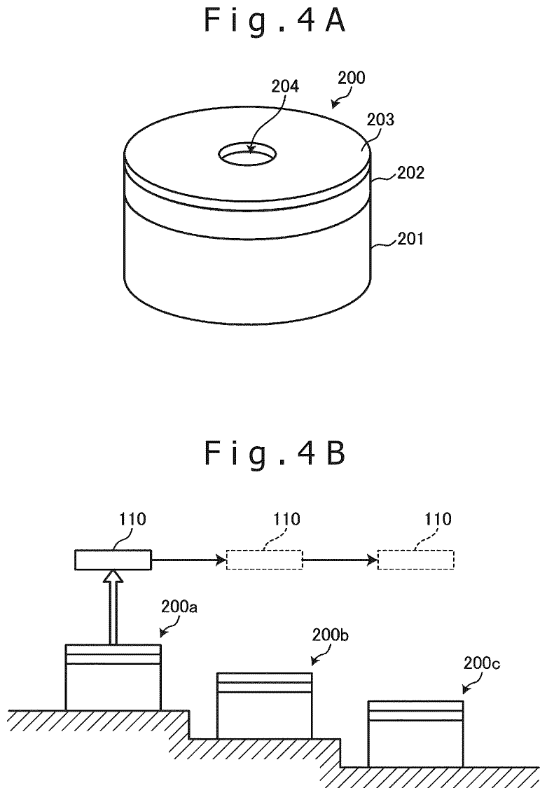

FIG. 4A is a diagram illustrating a configuration example of the correction light source according to the first embodiment of the present disclosure. FIG. 4A is a diagram illustrating a configuration example of the correction light source 200 used for generating the correction light source image. The correction light source 200 is configured by disposing an LED light source 202 and a slit 203 above a cylindrical housing 201. The slit 203 is disposed above the LED light source 202, and an opening 204 is formed in a center portion of the slit 203. The light ray of the LED light source 202 is narrowed by the opening 204, and thus, the correction light source is configured.

FIG. 4B is a diagram illustrating an example of the generation of the correction light source image according to the first embodiment of the present disclosure. FIG. 4B illustrates how the correction light source image is generated using correction light sources 200a, 200b, and 200c. The correction light sources 200a, 200b, and 200c are disposed at different heights. In this case, a distance between the imaging device 110 and each of the correction light sources 200a, 200b, and 200c corresponds to a corresponding one of the specific distances. The imaging device 110 is disposed above the correction light sources 200a, 200b, and 200c, and images the incident light rays from the correction light sources 200a and the like to generate the correction light source image. As illustrated in FIG. 4B, the imaging device 110 can generate the correction light source image by sequentially moving above the correction light sources 200a, 200b, and 200c. FIG. 4B illustrates an example of a case corresponding to three of the specific distances.

### Correction Information Generation Processing

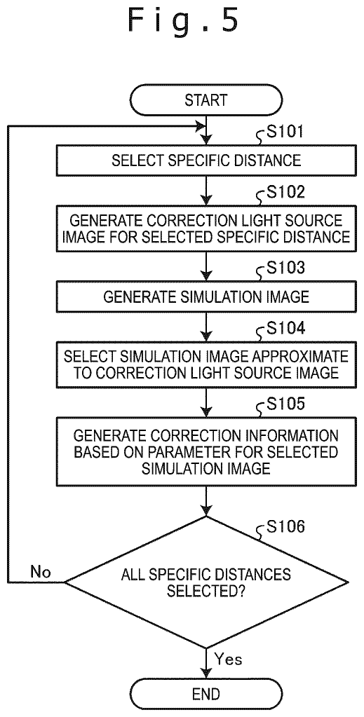

FIG. 5 is a chart showing an example of a processing procedure of correction information generation processing according to the first embodiment of the present disclosure. FIG. 5 is a flowchart showing the example of the processing procedure of the correction information generation processing by the calculation unit 122. First, the correction control unit 121 selects one of the plurality of specific distances (step S101), Next, the correction control unit 121 causes the imaging device 110 to generate the correction light source image for the selected specific distance (step S102). Next, the calculation unit 122 generates a simulation image (step S103). Here, the simulation image is an image generated assuming a case where a parameter such as the position of the mask 111 is changed with respect to the correction light source image that serves as a reference. In this manner, a plurality of the simulation images are generated by changing the parameter little by little.

Next, from among the simulation images, the calculation unit 122 selects a simulation image that is approximate to the correction light source image (step S104). Next, the calculation unit 122 generates the correction information, based on the parameter for the selected simulation image (step S105). Here, the calculation unit 122 can generate a correction value as the correction information. The correction value is, for example, a movement amount in an x direction or a y direction with respect to the restoration information. Next, the correction control unit 121 determines whether correction information generation is complete for all the specific distances (step S106). When the correction information generation is not complete for all the specific distances (step S106, No), the correction control unit 121 returns to the processing at step S101 and selects another of the specific distances (step S101), On the other hand, when the correction information generation is complete for all the specific distances (step S106, Yes), the correction control unit 121 ends the correction processing. The generated Correction information is output to and held by the holding unit 114.

In the configuration according to the present disclosure, it is possible to generate the correction light source image for each of the specific distances, to generate the correction light source image in which a degree of parallelization of the light ray and a light amount can be varied by a slit mechanism, and to generate the correction light source image in which the wavelength is variable. By comparing the correction light source image and the simulation image, the correction value or the like that is unique to the imaging device 110 and that most closely reflects a geometric positional relationship between the mask 111 and the imaging element 112 can be calculated.

As described above, the electronic apparatus 150 according to the first embodiment of the present disclosure generates the correction light source image by arranging the plurality of correction light sources 200, and generates the correction information of the restoration information for each of the specific distances. By correcting the restored image on the basis of the correction information, it is possible to acquire the restoration information with a high degree of accuracy.

### 3. Second Embodiment

Variations of the electronic apparatus 150 described above will be described.

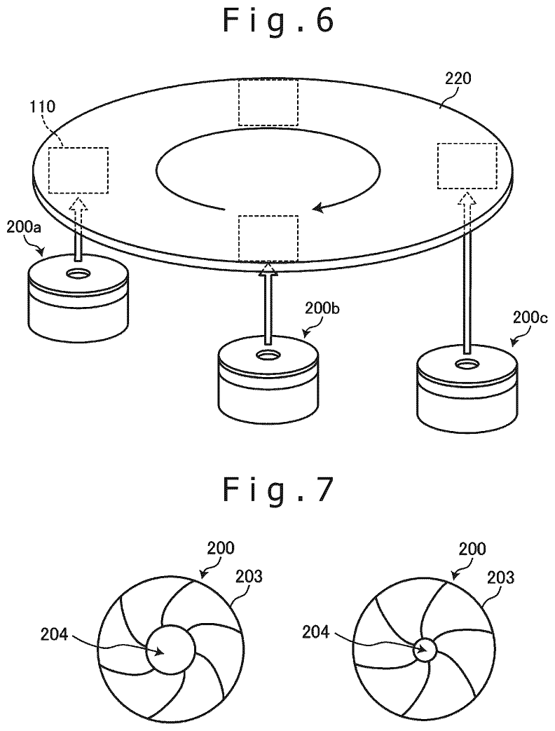

FIG. 6 is a diagram illustrating an example of the generation of the correction light source image according to a second embodiment of the present disclosure. Similarly to FIG. 4B, FIG. 6 is a diagram illustrating how the correction light source image is generated using the correction light sources 200a, 200b, and 200c. The imaging device 110 in FIG. 6 is attached to a disk-shaped holder 220. The correction light sources 200a, 200b, and 200c are arranged along the circumference of the holder 220. The holder 220 rotates to move the imaging device 110 to positions above the correction light sources 200a and the like. At this time, the correction light source image is generated. A plurality of the imaging devices 110 can be arranged on the holder 220, and a time for generating the correction light source image can be shortened.

FIG. 7 is a diagram illustrating a configuration example of the correction light source according to the second embodiment of the present disclosure. FIG. 7 is a diagram illustrating a configuration example of the correction light source 200. The correction light source 200 in FIG. 7 is illustrated as an example including the slit 203 that adjusts the size of the opening 204. For the correction light source 200, the size of the opening 204 can be adjusted in accordance with the specific distance. The correction light source 200 on the left side in FIG. 7 is illustrated as an example in which the opening 204 is adjusted to be relatively large. The correction light source 200 on the right side in FIG. 7 is illustrated as an example in which the opening 204 is adjusted to be relatively small.

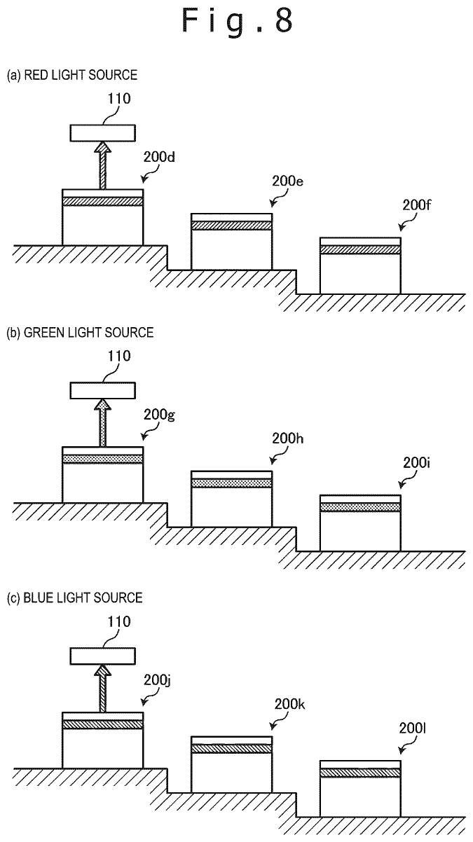

FIG. 8 is a diagram illustrating an example of an arrangement of the correction light sources according to the second embodiment of the present disclosure. FIG. 8 illustrates an example of a case where the correction light source image is generated using the correction light sources 200 for red light, green light, and blue light. FIG. 8(a) illustrates an example of correction light sources 200d, 200e, and 200f for the red light. FIG. 8(b) illustrates an example of correction light sources 200g, 200h, and 200i for the green light. FIG. 8(c) illustrates an example of correction light sources 200j, 200k, and 200l for the blue light.

In this case, the correction control unit 121 generates the correction light source image for each of the incident light rays having the different wavelengths from the correction light sources 200. The calculation unit 122 generates the correction information, based on the correction light source image for each of the incident light rays having the different wavelengths. By generating the correction light source images for the red light, the green light, and the blue light using the correction light sources 200, and applying the correction light source images to the correction of the restoration information, the accuracy of the restoration information can be improved.

Note that, instead of the correction light sources 200 for the red light, the green light, and the blue light, a filter that transmits the red light, a filter that transmits the green light, and a filter that transmits the blue light may be disposed in the correction light source 200 that emits white light. In this case, the red light, the green light, and the blue light can be switched by selecting the filter.

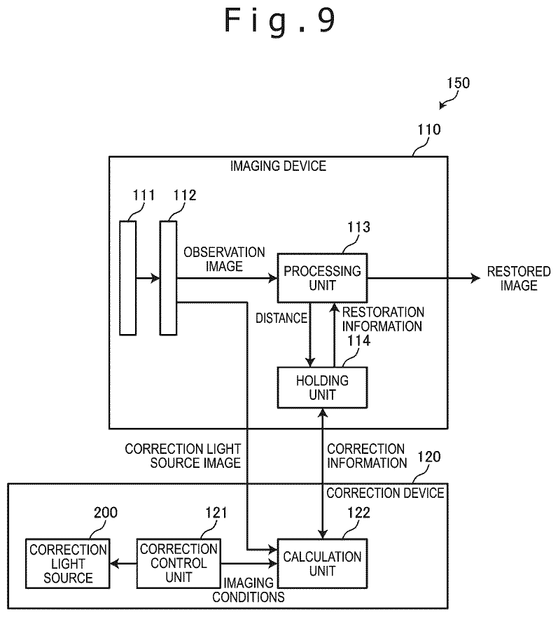

FIG. 9 is a diagram illustrating a configuration example of the correction device according to the second embodiment of the present disclosure. FIG. 9 is a block diagram illustrating the configuration example of the correction device 120. The correction device 120 in FIG. 9 is illustrated as an example of a case of including the correction light source 200, the correction control unit 121, and the calculation unit 122.

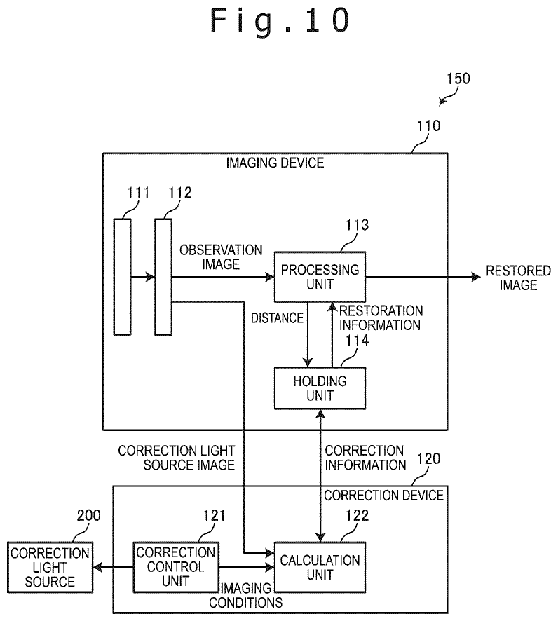

FIG. 10 is a diagram illustrating another configuration example of the correction device according to the second embodiment of the present disclosure. FIG. 10 is a block diagram illustrating the configuration example of the correction device 120. The correction device 120 in FIG. 10 is illustrated as an example of a case where the correction light source 200 is not included.

Other than those, the configurations of the electronic apparatus 150 are the same as the configuration of the electronic apparatus 150 according to the first embodiment of the present disclosure, and a description thereof will thus be omitted here.

### 4. Third Embodiment

Another configuration example of the electronic apparatus 150 will be described.

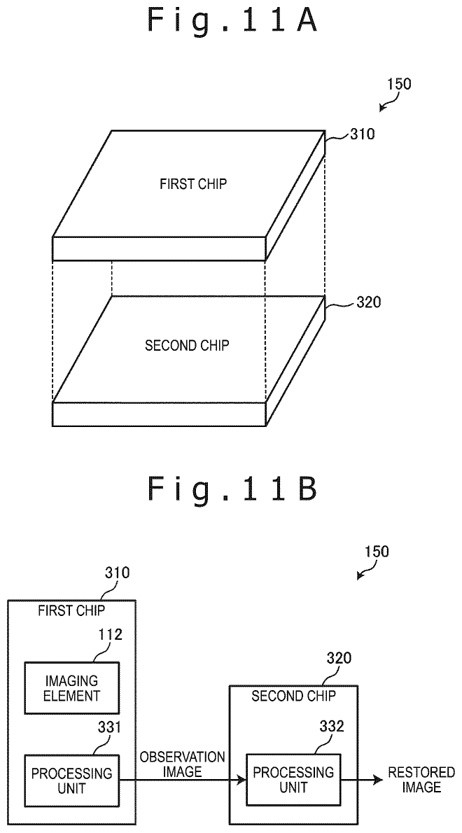

FIGS. 11A and 11B are diagrams illustrating a configuration example of the electronic apparatus according to the third embodiment of the present disclosure. FIG. 11A schematically illustrates the configuration example of the electronic apparatus 150. The electronic apparatus 150 in FIG. 11A is illustrated as an example of a configuration in which a first chip 310 and a second chip 320 are stacked.

FIG. 11B is a block diagram illustrating the configuration example of the electronic apparatus 150 corresponding to FIG. 11A. As illustrated in FIG. 11B, the imaging element 112 and a processing unit 331 are disposed in the first chip 310. The processing unit 331 performs, for example, processing of generating the observation image from the pixel signals output from the imaging element 112.

A processing unit 332 is disposed in the second chip 320. The processing unit 332 performs, for example, a process of generating the restored image from the observation image on the basis of the restoration information, and a process of correcting the restoration information. The processing unit 332 can also perform a process of generating the correction information.

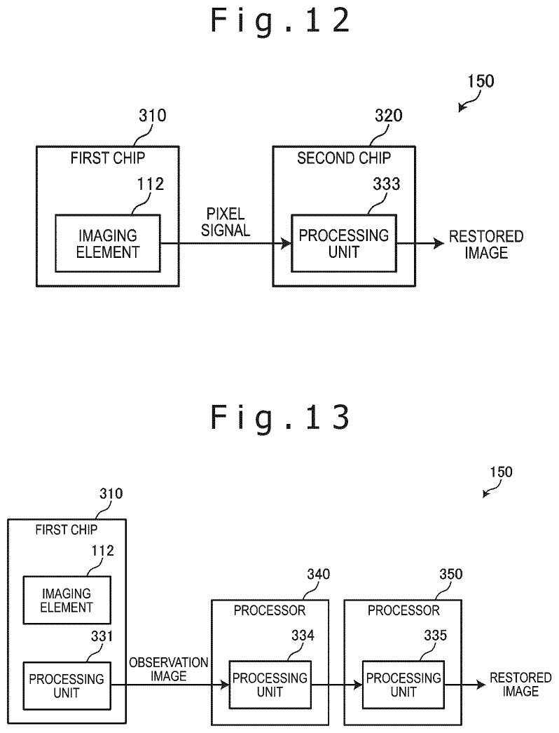

FIG. 12 is a diagram illustrating another configuration example of the electronic apparatus according to the third embodiment of the present disclosure. The imaging element 112 is disposed in the first chip 310 in FIG. 12. In addition, a processing unit 333 is disposed in the second chip 320 in FIG. 12. The processing unit 333 performs, for example, a process of generating the observation image from the pixel signals output from the imaging element 112, a process of generating the restored image from the observation image on the basis of the restoration information, and a process of correcting the restoration information. The processing unit 333 can also perform a process of generating the correction information.

FIG. 13 is a diagram illustrating another configuration example of the electronic apparatus according to the third embodiment of the present disclosure. FIG. 13 illustrates an example of the electronic apparatus 150 that includes the first chip 310 in which the imaging element 112 and the processing unit 331 are disposed, a processor 340, and a processor 350. A processing unit 334 is disposed in the processor 340. The processing unit 334 performs, for example, a process of generating the restored image from the observation image, based on the restoration information. A processing unit 335 is disposed in the processor 350. The processing unit 335 performs, for example, a process of correcting the restored image. The processing unit 335 can also perform a process of generating the correction information. Note that the processing of the processing units 334 and 335 may be performed by a server or the like. In this way, the process of generating the restored image and the process of correcting the restoration information are performed by different devices, and security can thus be enhanced.

Further, the processing described with reference to the flowchart and the sequence diagrams in the present specification need not necessarily be executed in the illustrated order. Some of the processing steps may be performed in parallel. Further, an additional processing step may be adopted, or some processing steps may be omitted.

Note that the effects described in the present specification are merely examples and are not limited, and other effects may be provided.

Note that the present technology can also have the following configurations.

(1)

A correction device that corrects restoration information in an imaging device. The imaging device includes a mask that modulates an incident light ray from a subject, an imaging element that images the incident light ray modulated by the mask and generates an observation image, and a processing unit that, based on the restoration information for each of a plurality of specific distances, performs a process of restoring an image of the subject, from the observation image, for each of the plurality of specific distances, the plurality of specific distances each being a distance to the subject that is a target of restoration of the image of the subject from the observation image. The correction device includes a correction control unit configured to perform control such that a plurality of correction light source images are generated, the plurality of correction light source images each being an image based on an incident light ray from a correction light source disposed for a corresponding one of the specific distances, and a calculation unit configured to generate correction information for correcting the restoration information for each of the specific distances, based on the plurality of correction light source images.

(2)

The correction device according to (1), in which the correction light source includes a slit configured to adjust a size of an opening.

(3)

The correction device according to (2), in which the correction light source emits light rays having a plurality of different wavelengths.

(4)

The correction device according to (3), in which the correction light source includes a light source of white light and a plurality of filters that respectively transmit the light rays having the different wavelengths.

(5)

The correction device according to any one of (1) to (4), in which the correction control unit generates the correction light source images respectively for the incident light rays having different wavelengths from the correction light source.

(6)

The correction device according to any one of (1) to (5), in which the calculation unit generates, as the correction information, a correction value for correcting the restoration information.

(7)

A correction method for correcting restoration information in an imaging device. The imaging device includes a mask that modulates an incident light ray from a subject, an imaging element that images the incident light ray modulated by the mask and generates an observation image, and a processing unit that, based on the restoration information for each of a plurality of specific distances, performs a process of restoring an image of the subject, from the observation image, for each of the plurality of specific distances, the plurality of specific distances each being a distance to the subject that is a target of restoration of the image of the subject from the observation image. The correction method includes generating a plurality of correction light source images each being an image based on an incident light ray from a correction light source disposed for a corresponding one of the specific distances, and correcting the restoration information for each of the specific distances, based on the plurality of correction light source images.

(8)

An electronic apparatus includes a mask configured to modulate an incident light ray from a subject, an imaging element configured to image the incident light ray modulated by the mask and generate an observation image, and a processing unit configured to, based on restoration information for each of a plurality of specific distances, perform a process of restoring an image of the subject, from the observation image, for each of the plurality of specific distances, the plurality of specific distances each being a distance to the subject that is a target of restoration of the image of the subject from the observation image. The electronic apparatus includes a correction control unit configured to perform control such that a plurality of correction light source images are generated, the plurality of correction light source images each being an image based on an incident light ray from a correction light source disposed for a corresponding one of the specific distances, and a calculation unit configured to correct the restoration information for each of the specific distances, based on the plurality of correction light source images.

### REFERENCE SIGNS LIST

110 Imaging device
111 Mask
112 Imaging element
113 Processing unit
120 Correction device
121 Correction control unit
122 Calculation unit
150 Electronic apparatus
200, 200a, 200b, 200c, 200d, 200e, 200f, 200g, 200h, 200i, 200j 200k, 200l Correction light source

1. A correction device configured to correct restoration information in an imaging device including a mask configured to modulate an incident light ray from a subject, an imaging element configured to image the incident light ray modulated by the mask and generate an observation image, and a processing unit configured to, based on the restoration information for each of a plurality of specific distances, perform a process of restoring an image of the subject, from the observation image, for each of the plurality of specific distances, the plurality of specific distances each being a distance to the subject that is a target of restoration of the image of the subject from the observation image, the correction device comprising:
a correction control unit configured to perform control such that a plurality of correction light source images are generated, the plurality of correction light source images each being an image based on an incident light ray from a correction light source disposed for a corresponding one of the specific distances; and
a calculation unit configured to generate correction information for correcting the restoration information for each of the specific distances, based on the plurality of correction light source images.

2. The correction device according to claim 1, wherein
the correction light source includes a slit configured to adjust a size of an opening.

3. The correction device according to claim 2, wherein
the correction light source emits light rays having a plurality of different wavelengths.

4. The correction device according to claim 3, wherein
the correction light source includes a light source of white light and a plurality of filters configured to respectively transmit the light rays having the different wavelengths.

5. The correction device according to claim 1, wherein
the correction control unit generates the correction light source images respectively for the incident light rays having different wavelengths from the correction light source.

6. The correction device according to claim 1, wherein
the calculation unit generates, as the correction information, a correction value for correcting the restoration information.

7. A correction method for correcting restoration information in an imaging device including a mask configured to modulate an incident light ray from a subject, an imaging element configured to image the incident light ray modulated by the mask and generate an observation image, and a processing unit configured to, based on the restoration information for each of a plurality of specific distances, perform a process of restoring an image of the subject, from the observation image, for each of the plurality of specific distances, the plurality of specific distances each being a distance to the subject that is a target of restoration of the image of the subject from the observation image, the correction method comprising:
generating a plurality of correction light source images each being an image based on an incident light ray from a correction light source disposed for a corresponding one of the specific distances; and
generating correction information for correcting the restoration information for each of the specific distances, based on the plurality of correction light source images.

8. An electronic apparatus comprising:
a mask configured to modulate an incident light ray from a subject;
an imaging element configured to image the incident light ray modulated by the mask and generate an observation image;
a processing unit configured to, based on restoration information for each of a plurality of specific distances, perform a process of restoring an image of the subject, from the observation image, for each of the plurality of specific distances, the plurality of specific distances each being a distance to the subject that is a target of restoration of the image of the subject from the observation image;
a correction control unit configured to perform control such that a plurality of correction light source images are generated, the plurality of correction light source images each being an image based on an incident light ray from a correction light source disposed for a corresponding one of the specific distances; and
a calculation unit configured to generate correction information for correcting the restoration information for each of the specific distances, based on the plurality of correction light source images.
